(19) United States
(12) Patent Application Publication
(10) Pub. No.: US 2021/0189228 A1
(43) Pub. Date: Jun. 24, 2021

(54) LOW TEMPERATURE BREAKER FOR WELL TREATMENT FLUIDS CONTAINING POLYACRYLAMIDE

(71) Applicant: Finorlc, LLC, Beasley, TX (US)

(72) Inventors: Deepak Patil, Friendswood, TX (US); Ambrish Kamdar, Beasley, TX (US); Oscar Portillo, Richmond, TX (US)

(73) Assignee: Finorlc, LLC, Beasley, TX (US)

(21) Appl. No.: 17/129,594

(22) Filed: Dec. 21, 2020

Related U.S. Application Data
(60) Provisional application No. 62/951,757, filed on Dec. 20, 2019.

(51) Int. Cl. C09K 8/88; C09K 8/70

(52) U.S. Cl. CPC C09K 8/887; C09K 8/706

(57) ABSTRACT

A method for treating a zone of a well is provided, wherein the fluid is adapted to break in the zone of the well. The method includes the steps of: (A) introducing a well treatment fluid into a desired zone of the well, wherein the well fluid includes: (i) a water phase; (ii) a water-soluble polymer, such as derivatized polyacrylamide, soluble in the water phase; and (iii) an aldehyde or ketone or a source compound that releases the aldehyde or ketone; and (B) allowing the viscosity of the well fluid to break in the zone or proppant pack, and/or, increasing the solubility of the polyacrylamide polymer and reduce formation damage.

### REFERENCE TO RELATED APPLICATIONS

This non-provisional US patent application claims priority under 35 USC § 119(e) to provisional US application having Ser. No. 62/951,757, filed 20 Dec. 2019, having the same title and inventors. The contents of the above-referenced application are incorporated by reference.

### FIELD

The invention relates, generally, to the breaking of the polymers used in well treatment fluids containing polymeric fluids, especially polyacrylamide, by increasing the solubility and dispersion of the polymer. In an embodiment, the invention can facilitate polymer breaking at temperatures as low as 27° C. (80° F.).

### BACKGROUND

In hydraulic fracking, it is often desired to increase the viscosity of a fracking fluid for better suspension and carrying of particulate well treatment chemicals such as proppants. This is done through viscosifying agents, or “viscosifiers,” which are often naturally occurring polymers such as polysaccharides, synthetic polymers such as polyacrylamides, galactomannans, and derivatives thereof. The viscosifying activity of these agents can be further enhanced through the use of “crosslinkers,” most commonly salts or compounds including metallic ions, which can gel the fluid further, often on a delayed reaction which allows operators to time the viscosifying to take place at a certain formation depth.

Natural and synthetic polymers may also be used as friction reducers to reduce the force necessary to transport the fluid to a particular formation depth. Polyacrylamides are particularly preferred in the field as they are suitable for both viscosifying and reducing friction.

Once the fracking operation is completed, the viscosified fluid must be removed from the formation to leave behind the proppants or other chemicals transported therewith. This requires lowering the viscosity to enable the fluid to be easily pumped back out, referred to as “breaking.” (Despite the name, breaking agents, or “breakers,” do not necessarily break or even alter the chemical backbone of the polymer.)

Known methods of using breakers to modify the polymer by reacting with other chemicals include those described in U.S. Pat. No. 9,422,420, incorporated herein by reference. This method shows controlled degradation and breaking of a fluid viscosified with a polyacrylamide by lowering its viscosity. Additionally, U.S. Pat. App. No. 20150175877, incorporated herein by reference, shows the effects of aldehyde as a biocide and for breaking a viscosified polyacrylamide by lowering its viscosity. Both of these references rely on direct lowering of viscosity.

However, chemicals which act as both viscosifiers and friction reducers, such as polyacrylamide, can interact with the various metals in the formation, or crosslinking agents, to produce lower solubility products that may be too viscous, or even solid, for a standard breaker. In many applications, the amount of polyacrylamide used in the fluids is not enough to increase the viscosity substantially. However, once the fluid is injected into the formation, less than half returns to the surface in the following weeks. Depending on the water quality of the specific formation, the polyacrylamide content can precipitate into rubbery particles or “slugs.” These slugs impede the flow of fluids from the formation, and cause formation damage. This is especially true of polyacrylamide fluids utilized at lower temperatures, e.g., less than 50° C. (122° F.).

A need exists for a fluid which indirectly modifies the solubility and dispersion of the friction reducers, without necessarily reducing the viscosity directly, in order to prevent formation damage caused by overly viscous fluids and friction reducers, and allow the use of polyacrylamide at a wider range of temperatures than allowed by the current state of the an.

Embodiments of the invention as described herein meet this need.

### SUMMARY OF THE INVENTION

A method for treating a zone of a well with a fluid containing polyacrylamide based friction reducing agents is provided, wherein the fluid is adapted to break in the well. The method includes the steps of: (a) introducing a well fluid into the zone of the well, wherein the well fluid includes: (i) a water phase; (ii) a water-soluble polyacrylamide, polysaccharide, or galactomannan; and (iii) a source of a carbonyl compounds such as an aldehyde or ketone; and (b) allowing the polyacrylamide polymer to break in the zone and/or in the proppant pack.

In an embodiment, the “breaking” may occur with little to no change in viscosity. Instead, the breaking is achieved by modifying the viscosifying agent and/or friction reducer, which may produce high viscosity liquids or solids from conventional breakers or metals present in the formation, to increase its solubility and/or dispersibility.

While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DRAWINGS

Throughout the disclosure, reference is made to the following figures, to help illustrate embodiments according to the invention. All fluids were treated at the designated temperature and for desired amount of time, then cooled to room temperature to measure viscosity.

FIG. 1 is a graph showing the degradation of viscosity for an aqueous fluid of 12 gal/1000 gal acrylamide polymer emulsion with varying concentrations of paraformaldehyde solid and liquid glyoxal at room temperature to 27° C. (80° F.).

FIG. 2 is a graph showing the degradation of viscosity for an aqueous fluid of 12 gal/1000 gal acrylamide polymer emulsion with varying concentrations of liquid glyoxal at room temperature to 66° C. (150° F.).

FIG. 3 is a graph showing the degradation of viscosity for an aqueous fluid of 12 gal/1000 gal acrylamide polymer emulsion with varying concentrations of liquid glutaraldehyde at room temperature to 66° C. (150° F.).

FIG. 4 is a graph showing the degradation of viscosity for an aqueous fluid of 10 gal/1000 gal acrylamide polymer emulsion with a conventional sodium chlorite breaker and further treated with liquid glyoxal at 70° C. (158° F.).

FIGS. 5A and 5B are photos showing the degradation and dispersion of polyacrylamide solids obtained from an oil well before and after treatment with paraformaldehyde at room temperature.

### DETAILED DESCRIPTION OF THE INVENTION

Before describing selected embodiments of the present disclosure in detail, it is to be understood that the invention is not limited to the particular embodiments described herein, which are illustrative and explanatory of one or more embodiments and variations thereof. It can be appreciated by those skilled in the art that various changes in the general methodology and use of chemical equivalents may be made without departing from the spirit of the invention. Words or terms used herein have their plain, ordinary meaning in the field of this disclosure, except to the extent explicitly and clearly defined in this disclosure or unless the specific context otherwise requires a different meaning. If there is any conflict in the usages of a word or term in this disclosure and one or more patent(s) or other documents that may be incorporated by reference, the definitions consistent with this specification should be adopted.

Controlled breaking of well treatment fluid containing polyacrylamide friction reducing agents is a challenge. Most oxidizing breakers either break the fluid too quickly or do not work at all in low temperatures. In addition, the degradation product, once oxidized, has the capability to re-heal and return to high viscosity as the temperature drops.

Thus, the effect of these breakers may be strictly temporary. In general, production starts after completion of well services. It is a well-known fact that only about 30-50% of the fluids return within the first few weeks after the well has started producing. Since these breakers have only a temporary effect, the fluids will re-heal and return to high viscosity making it harder for the fluids to flow out of the shale.

A new chemical method is provided for controllable fluid breaks of polyacrylamide polymers used as friction reducing agents. The method has application for a number of polyacrylamide polymers applications in a well. These include slick water hydraulic fracturing, crosslinked polymeric systems such as those using a derivatized polyacrylamide or an AMPS-acrylamide-acrylic acid co-polymer, and acidizing and conformance applications that use such polymers.

Aldehydes and ketones have demonstrated breaker capabilities for polyacrylamides and derivatized polyacrylamides in well fluid applications. Non-limiting examples of aldehydes are formaldehyde, acetaldehyde, propionaldehyde, glyoxal, glutaraldehyde, acrolein, etc. Non-limiting examples of ketones are acetone, methyl ethyl ketone, diethyl ketone, etc.

The use of these compounds as breakers that permanently modify the polyacrylamide polymers used as friction reducing agents has the additional benefit of preventing the fluids from returning to high viscosity, making it easier for the fluids to flow out of the zone or well.

In breaking these friction reducers, the viscosity of the fluid containing the polyacrylamide type polymers is not necessarily reduced. The viscosity after the treatment of aldehydes, ketones, or compounds releasing aldehydes and ketones may be same or even higher than the viscosity of the fluid before the treatment. The aldehydes, ketones, or compounds that release aldehydes or ketones modify the polymer to increase its water solubility and dispersion. This permits removal of very viscous fluids or solids produced from friction reducers, preventing formation damage.

There are numerous ways of measuring and modeling solubility and dispersibility, depending on the type of fluid being measured. Typical methods for quality assurance or quality control (QA/OC) purposes include visual methods, turbidity, evaporating the fluid to determine solids content, etc.

This invention can give a new tool for using polyacrylamide polymers used as friction reducing polymers for oil and gas application such as hydraulic fracturing, acidizing, conformance control, coiled tubing, etc. For example, such aldehydes and ketones can be used as breakers for a derivatized polyacrylamide cross linker or friction reducer at room temperatures of 27° C. (80° F.). At higher temperatures, the breakers work even faster.

One advantage of using such aldehydes and ketones as breakers for polyacrylamide polymers used as friction reducer polymers is that a controllable fluid break is possible at such low temperatures. The challenges of breaking polyacrylamide polymers used as friction reducers in aqueous environments at low temperatures are noted in the industry. Embodiments of the invention disclosed herein have the capability to break these polymers rapidly in less than 24 hours at temperature less than or equal to 27° C. (28° F.).

According to the invention, a method for treating a zone of a well with a fluid containing polyacrylamide is provided, wherein the break time of the polyacrylamide is adapted to break in the well. The method includes the steps of: (A) introducing a well treatment fluid into the zone of the well, wherein the well treatment fluid includes: (i) a water phase; (ii) a water-soluble polymer in the water phase; and (iii) a source of a aldehyde or ketone; and (B) allowing the polyacrylamide polymer of the well treatment fluid to break in the zone or proppant pack.

In an embodiment, the water phase may include surfactants (e.g., viscoelastic, cationic, anionic, non-ionic, or zwitterionic surfactant) which aid in viscosifying the fluid.

In an embodiment, the aldehyde and/or ketone may be part of a coordination complex (also referred to as a “metal complex” or “adduct”), particularly if a slower reaction rate is desired. For example, a compound such as bisulfate will bind with the aldehyde and/or ketone to obstruct its activity and delay the breaking action.

In an embodiment, the aldehyde and/or ketone may be generated from a precursor compound, such as an acetal and/or ketal. These precursor compounds also act to slow the reaction rate by inserting an intermediate hydration step, wherein the acetal and/or ketal precursor first reacts with the water to produce an aldehyde and/or ketone.

In an embodiment, the aldehyde and ketone is water soluble and dispersed/dissolved in the water phase. In an embodiment, the aldehyde and/or ketone is selected from the group consisting of formaldehyde, acetaldehyde, propionaldehyde, glyoxal, glutaraldehyde, acrolein, acetone, methyl ethyl ketone, diethyl ketone and any combination thereof. In an embodiment, the aldehyde and/or ketone comprise glyoxal and/or glutaraldehyde. In an embodiment, the aldehyde and ketone am included in a well fluid in a form and concentration selected to achieve breaking at a desired time.

In an embodiment, the aldehyde and/or ketone are present in a concentration less than 1% by weight of the well treatment fluid. In a further embodiment, the aldehyde and/or ketone are present in a concentration of less than 0.1% by weight of the well treatment fluid.

Other secondary breakers may be used in conjunction with the aldehyde and ketone breakers. These secondary breakers may be oxidizers, acidic, enzymatic, or any combination thereof. Any or all the breakers including the breakers of this invention may be unmodified or encapsulated to delay the effect of the breakers and blended directly with the well fluid. For instance, the aldehyde and ketone breaker may be used in conjunction with ammonium persulfate or sodium bromate, and the aldehyde and/or ketone breaker, or the secondary breakers, or both, may be encapsulated in a polymeric coating.

In an embodiment, the aldehyde or ketone may be part of a micro-emulsion, or nano-emulsion. These comprise a continuous oil phase, a dispersed aqueous phase, and a surfactant. The continuous oil phase may be any suitable mineral oil or vegetable oil. The dispersed aqueous phase comprises the aldehyde. The surfactant may be, e.g. a viscoelastic, cationic, anionic, non-ionic, or zwitterionic surfactant which breaks down the emulsion and slowly exposes the dispersed aqueous phase to the well fluid. A micro-emulsion comprises a suspension where the droplet size of the dispersed (i.e., aqueous) phase is smaller than 500 um. A nano-emulsion comprises a suspension where the droplet size of the dispersed phase is smaller than 1 um.

In an embodiment, the method includes the step of controlling the breaking time at the design temperature by adjusting the concentration of the breakers disclosed.

The method has particular application to wells having a temperature of less than 27° C. (80° F.), where breaking time can be controlled to be less than about 24 hours, depending on the concentration of the polyacrylamide in the well treatment fluid, the concentration of aldehyde and/or ketone, and temperature of the well.

The viscosity of water is typically one centipoise. The fluid prepared by service companies may include polyacrylamide at concentrations which increase the viscosity only slightly, e.g., to 1.1 centipoise. In such cases, it is not prudent to monitor the breaking rate or time. The experimental error range is usually about 0.5 centipoise, making the correlation of data difficult. Therefore, the visual appearance of the fluid is monitored for the appearance of solids, as the solids or extremely viscous slugs of liquid can damage the formation. It has been discovered that, using the breakers of the invention embodied herein, the frequency of precipitating such solids or extremely viscous slugs of liquid are reduced dramatically.

To demonstrate this discovery, rubbery polyacrylamide solids from a well were obtained and treated with the breakers of invention to make the solids water soluble and dispersible in the solvent again.

### Examples

To facilitate a better understanding of the present invention, the following examples of certain aspects of some embodiments are given. In no way should the following examples be read to limit, or define, the entire scope of the invention. All test fluids are water-based fluids.

Formaldehyde, acetaldehyde, propionaldehyde, glyoxal, glutaraldehyde, acrolein, acetone, methyl ethyl ketone, diethyl ketone are commercially available from many vendors. The derivatized “polyacrylamide.” as used in the following examples, is about 30% by weight copolymer of acrylamide (70%) and ammonium salt of acrylic acid (30%) in an inverse emulsion. The inverse emulsion can break upon dilution with water in the test fluids to release the copolymer into the water.

The test samples were treated at desired temperature for a desired time, then cooled to room temperature. All samples were cooled to room temperature to ascertain that the “viscosity reduction” or “break” was not temporary and verify the fluid did not “re-heal” and regain viscosity. The viscosity measurements from 3 RPM to 600 RPM shear rate were performed using an Ofite 900 viscometer.

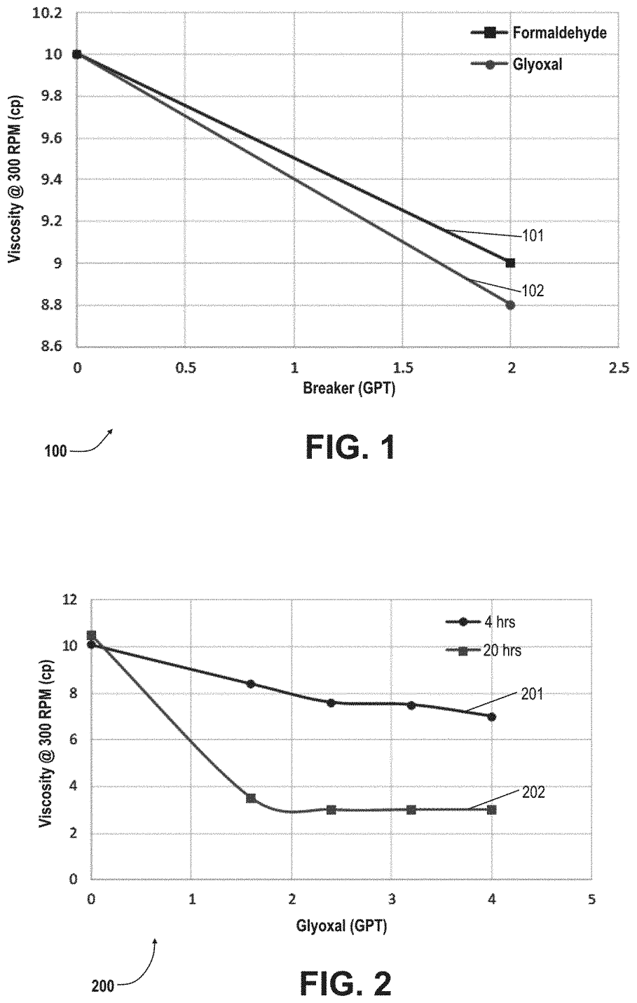

Turning now to FIG. 1, a graph (100) is shown of degradation of high viscosity for two aqueous fluids of 12 gal/1000 gal (45 L/3785 L) derivatized polyacrylamide comparing the abilities of paraformaldehyde (10) and glyoxal (102) to break the fluid at room temperature at 27° C. (80° F.).

Increasing the concentration of paraformaldehyde and glyoxal results in a shorter time for the decreasing the viscosity of the fluid system. Accordingly, the degradation of the fluid viscosity can be controlled by varying the concentration of parafomaldehyde or glyoxal. With varying dilution of paraformaldehyde or glyoxal the desired degradation time can be achieved. This shows that glyoxal can be successfully used as breaker even at the lower temperature 27° C. (80*F).

Turning now to FIG. 2, a graph (200) is shown of degradation of viscosity for an aqueous fluid of 12 gal/1000 gal (45 L/3785 L) with derivatized polyacrylamide with concentrations of glyoxal at 67° C. (150° F.). Runs of 4 hours (201) and 20 hours (202) are shown. In addition, for this fluid system with a concentration of glyoxal at 1.6 gal/1000 gal (6 L/3785 L) fluid to 4 gal/1000 gal (15 L/3785 L) fluid, the viscosity of the fluid does not re-heal, from which it can be inferred that the glyoxal is permanently breaking down the polymer network.

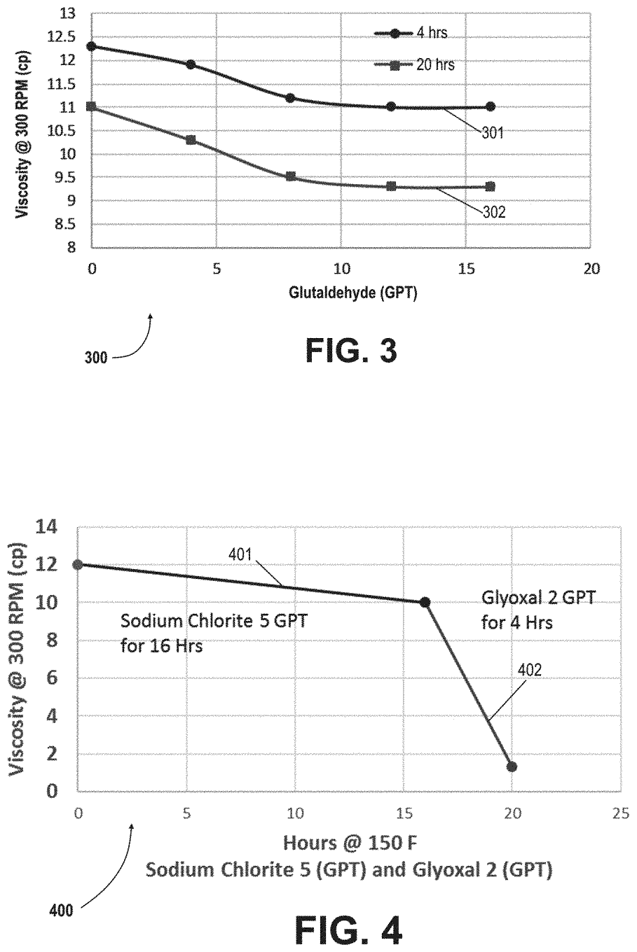

Turning now to FIG. 3, a graph (300) is shown of degradation of viscosity for an aqueous fluid of 12 gal/1000 gal (45 L/3785 L) with derivatized polyacrylamide with concentrations of 50% glutaraldehyde at 67° C. (150° F.). Runs of 4 hours (301) and 20 hours (302) are shown. In addition, for this fluid system with a concentration of glyoxal at 4 gal/1000 gal (15 L/3785 L) fluid to 16 gal/1000 gal (60 L/3785 L) fluid, the viscosity of the fluid does not re-heal, from which it can be inferred that the 50% glutaraldehyde is permanently breaking down the polymer network.

Turning now to FIG. 4, a graph (400) is shown of degradation of viscosity for a 10 gal/1000 gal (38 L/3785 L) fluid of 12 cp viscosity with a conventional sodium chlorite breaker treated at 70° C. (158° F.) for 16 hours (401). The resulting solution separates over 2 days containing a few very high viscosity spots. The liquid was again mixed and the viscosity was measured as 10 cp. On remixing the entire fluid which was partially degraded with sodium chlorite, was further treated with glyoxal at 70° C. (158° F.) for 4 hours (402). The viscosity of the fluid was measured again which was 1.3 cp. The glyoxal, in this case has modified the polyacrylamide to reverse the formation of very viscous spots of liquid to a uniform liquid by increasing its solubility and dispersibility. This clearly shows three things; first, the very viscous spots of friction reducer broken with sodium chlorite oxidizer was modified to prevent the high viscosity spots; second, the conventional breakers can be used synergistically with the breakers of this invention; and third, the very high viscosity spots were reversed which will prevent formation damage.

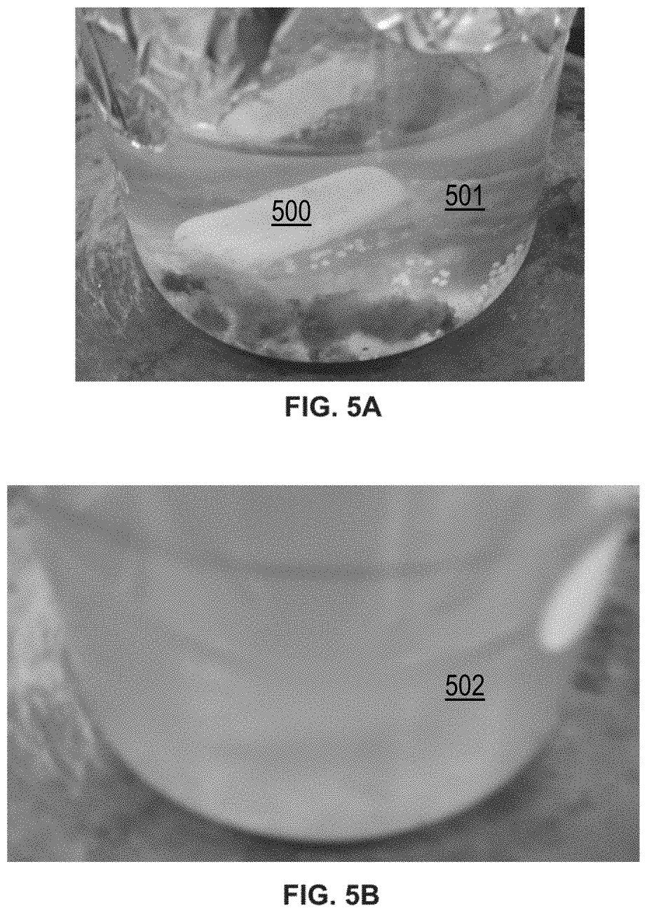

Turning now to FIGS. 5A and 5B, a photograph is shown of degradation of rubbery polyacrylamide solids insoluble in water. The solids (500) in FIG. 5A were treated at 75° F. (24° C.) for 16 hours with parafomaldehyde in the solution (501) which has permanently degraded, dissolved and dispersed the polymer network of these solids, as shown in FIG. 5B. In this case, the viscosity of the resulting fluid (502) is not reduced but actually increased. The fluid, comprised of water with the breaker, serves as the media to disperse the polymer. Initial viscosity of the fluid is 0.95 CP and the final viscosity is 2.3 CP. The paraformaldehyde in this case has modified the polyacrylamide to increase its solubility and dispersion.

The invention permits prediction and dosing the desired quantity of aldehyde or ketone into the fracturing fluid and eventually reducing the viscosity or the fluid or breaking the fluid. In the following statements, the term “break” is used to indicate viscosity reduction, “breaker” is used to indicate the aldehyde or ketone. The time required to break the fluid, “break time” is inversely proportional to the “break rate” or the speed at which the fluid is broken The discovery notes the following observations; a) the break rate is directly proportional to the well or zone's bottom hole temperature “BHT”, b) the break rate is directly proportional to the concentration of the breaker, c) the break rate is inversely proportional to the ratio of the polyacrylamide concentration to the “breaker”; d) the break rate is inversely proportional to the starting concentration of the polyacrylamide dosage; and e) the break rate is inversely proportional to the starting viscosity of the fluid.

It should be noted that there are various types of polyacrylamide polymers with three main subcategories, i.e., nonionic, anionic and cationic. In addition, the molecular weight of each type polymer may vary from 5 million Daltons to 30 million Daltons. The starting viscosity, or “Initial Viscosity or V_{I}” at a certain dosage can be reduced to a “Final Viscosity or V_{F}” fraction of the original viscosity. This fraction depends upon the suitability of the polymer for certain fluids. These polymers are manufactured for applications using various sources of water with varying levels of salts, and the salt solution is called brine. The polymers are specifically made for various applications in which a) fresh water, b) low to mid brine, c) high brine, and d) high viscosity polymer.

Treatment of each of these polyacrylamides with different “breaker” treated for infinite time at the desired conditions will be called “Terminal Viscosity, or V_{T}”. In practice, “V_{T}” will be the viscosity of the fluid after treating with 300% excess breaker at room temperature “RT” for at least 2 weeks. The excess breaker will assure the polymer undergoes maximum change.

In each of these polymers the starting viscosity and final viscosity after treating it with the breakers of this invention will depend on the subcategory of the polymer (nonionic, cationic, or anionic), molecular weight, the breaker itself, and the bottom hole temperature. Other parameters including, but not limited to, water hardness and salinity can also play a role in the final viscosity. For instance, the higher concentrations of dissolved minerals in hard water will reduce the difference between initial viscosity V_{I} and final viscosity V_{F} as the mineral ions compete with the crosslinkers to react with the polyacrylamide such that it does not properly suspend and therefore requires less breaker.

Only as an example, the prediction equation is presented for polyacrylamide to be used with fluid prepared with fresh water. The equation presented below permits one to calculate the dosage of the “breaker” is presented below:

$$Breaker GPT ∝ T \times \frac{Polyacrylamide GPT}{{( BHT / RT )}^{b}} \times \frac{{( {V}_{I} - {V}_{F} )}^{a}}{{( {V}_{I} - {V}_{T} )}^{c}}$$

As depicted, Breaker GPT equals gallons of breaker per 1000 gallons of fluid and Polyacrylamide GPT equals gallons of Polyacrylamide per 1000 gallons of fluid, where GPT is a dimensionless unit of measure depicting the ratio of volume of additive to the volume of fluid. T equals time in hours, a/b/c arc constants which vary for each polymer. BHT equals bottom hole temperature, RT equals room temperature, VI equals initial viscosity, VF equals final viscosity, and VT equals Terminal Viscosity. Viscosity may be measured in units of centipoise, centistoke, or reciprocal seconds, while BHT and RT may be measured in any degree units (° C., ° F., ° K), as long as the units used are consistent.

If the viscosity of fluid containing polyacrylamide (or other) polymers is lower than 3 cP, it would be prudent to record visual changes in solubility and dispersibility, or use other analytical tools to quantify the amount of solids in the fluid. Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention. The various elements or steps according to the disclosed elements or steps can be combined advantageously or practiced together in various combinations or sub-combinations of elements or sequences of steps to increase the efficiency and benefits that can be obtained from the invention. The invention illustratively disclosed herein suitably may be practiced in the absence of any element or step that is not specifically disclosed or claimed.

1. A method for treating a zone of a well, comprising:
introducing a well treatment fluid into the zone of a well, the well treatment fluid comprising a water phase, a water-soluble polymer at between 0.01 and 10 wt %, and a water-soluble source of an aldehyde or ketone at less than 1 wt %; and
adjusting the concentration of the water-soluble source of the aldehyde or ketone to ensure the aldehyde or ketone breaks the water-soluble polymer within the zone,
wherein the zone has a bottom hole temperature of 70° C. or less, and wherein the water-soluble aldehyde or ketone increases the solubility of the water-soluble polymer.

2. The method of claim 1, wherein the zone has a bottom hole temperature of 27° C. or less.

3. The method of claim 1, wherein the water-soluble source of aldehyde or ketone comprises formaldehyde, acetaldehyde, propionaldehyde, glyoxal, glutaraldehyde, acrolein, acetone, methyl ethyl ketone, diethyl ketone, or combinations thereof.

4. The method of claim 3, wherein the water-soluble source of aldehyde or ketone comprises an adduct, such as a bisulfite adduct.

5. The method of claim 3, wherein the water-soluble source of aldehyde or ketone is supplied is a precursor compound.

6. The method of claim 3, wherein the water-soluble source of aldehyde or ketone is encapsulated.

7. The method of claim 3, wherein the water-soluble source of aldehyde or ketone comprises a micro or nano emulsion.

8. The method of claim 1, wherein the water-soluble polymer comprises a polyacrylamide, polysaccharide, galactomannan, or combinations and derivatives thereof.

9. The method of claim 1, wherein the well treatment fluid further comprises a crosslinker.

10. The method of claim 1, wherein the well treatment fluid further comprises a viscoelastic, non-ionic, cationic, anionic, or zwitterionic surfactant.
